(19) United States
(12) Patent Application Publication
(10) Pub. No.: US 2018/0244237 A1
(43) Pub. Date: Aug. 30, 2018

(54) CARGO ALARM SYSTEM

(71) Applicant: John Slack, Priddis (CA)

(72) Inventor: John Slack, Priddis (CA)

(21) Appl. No.: 15/442,798

(22) Filed: Feb. 27, 2017

(51) Int. Cl. B60R 25/10

(52) U.S. Cl. CPC B60R 25/10; B60R 2025/1013

(57) ABSTRACT

A cargo alarm system has an alarm housing mounted to a vehicle. An alarm unit is contained by the alarm system housing. A first electrical connector is electrically connected to the alarm unit. A second electrical connector is electrically connected to the alarm unit. An electrical cable is electrically connectable at one end to the first electrical connector and at the opposite end to the second electrical connector. The alarm unit operates to detect cutting or unplugging of the electrical cable and generating an alarm signal in response.

### FIELD OF THE INVENTION

The present invention relates generally to anti-theft alarm systems, and, more particularly, relating to an alarm system for preventing theft of cargo being transported by a vehicle.

### BACKGROUND OF THE INVENTION

Articles are often transported on the back of a pick-up truck or on a trailer. For example, all-terrain vehicles, motorcycles, wave runners, and other vehicles are often carried by a trailer that is connected to a towing vehicle. Additionally, construction equipment, tools, electrical generators, etc. are often carried on the back of a pick-up truck and/or trailer. These articles are often left unattended and exposed to potential theft.

Alarm systems exist that operate to prevent theft of trailers. These alarm systems operate by causing the towing vehicle's anti-theft alarm system to generate an alarm signal upon the alarm system detects an unauthorized trailer disconnect from the towing vehicle. Examples of such trailer alarm systems are described by U.S. Pat. Nos. 9,199,521 and 8,031,061, each of which are incorporated herein by reference in its entirety.

While existing trailer alarm devices fulfill their respective, particular objectives and requirements, there exists and need for a new cargo alarm system, which substantially departs from the prior art, and in doing so provides an apparatus primarily developed for the purpose of articles carried by pick-up trucks and trailers against theft.

### SUMMARY OF THE INVENTION

In view of the foregoing disadvantages inherent in the known cargo alarm systems, the present invention provides a new cargo alarm system construction.

In general, in one aspect, an alarm system has an alarm system housing mounted to a vehicle. An alarm unit is contained by the alarm system housing. A first electrical connector electrically connected to the alarm unit and a second electrical connector is electrically connected to the alarm unit. An electrical cable is electrically connectable at one end to the first electrical connector and at the opposite end to the second electrical connector, wherein alarm unit operates to detect cutting or unplugging of the electrical cable and generates an alarm signal in response.

In general, in another aspect, an alarm system has a master alarm having a master alarm housing mounted to a vehicle, a master alarm unit contained by the master alarm housing, a first electrical connector electrically connected to the master alarm unit, a second electrical connector electrically connected to the master alarm unit, a master alarm electrical cable electrically connectable at one end to the first electrical connector and at the opposite end to the second electrical connector. The alarm system further includes a slave alarm having housing mounted to a vehicle, a slave alarm unit contained by the slave alarm housing, a third electrical connector electrically connected to the slave alarm unit, a fourth electrical connector electrically connected to the slave alarm unit, a slave alarm electrical cable electrically connectable at one end to the third electrical connector and at the opposite end to the fourth electrical connector. The slave alarm unit and the master alarm unit electrically connected together. The master alarm unit operates to detect cutting or unplugging of the master electrical cable and generating an alarm signal in response and the slave alarm unit operates to detect cutting or unplugging of the slave electrical cable and generating an alarm signal in response.

In general, in another aspect, an alarm system has a towing vehicle alarm system associated with a towing vehicle and a towing vehicle electrical connector electrically connected to the towing vehicle alarm system. The system further includes a towed vehicle alarm system associated with a towed vehicle and a towed vehicle electrical connector electrically connected to the towed vehicle alarm system. A cable is electrically connected at opposite ends to the towing vehicle electrical connector and the towed vehicle electrical connector. Each of the towing vehicle alarm system and the towed vehicle alarm system generate an alarm signal upon detecting an electrical separation between the towing vehicle alarm system and the towed vehicle alarm system.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic view of a cargo alarm system according to a first embodiment;

FIG. 2 is a block diagram of a cargo alarm system according to the first embodiment;

FIG. 3 a diagrammatic view of the cargo alarm system according to the first embodiment in an alternative configuration;

FIG. 4 is a diagrammatic view of a cargo alarm system according to a second embodiment;

FIG. 5 is a block diagram of a cargo alarm system according to the second embodiment;

FIG. 6 is a diagrammatic view of a cargo alarm system according to a third embodiment;

FIG. 7 is a block diagram of a cargo alarm system according to the third embodiment; and

FIG. 8 is a diagrammatic view of an alternate configuration of a cargo alarm.

### DETAILED DESCRIPTION OF THE INVENTION

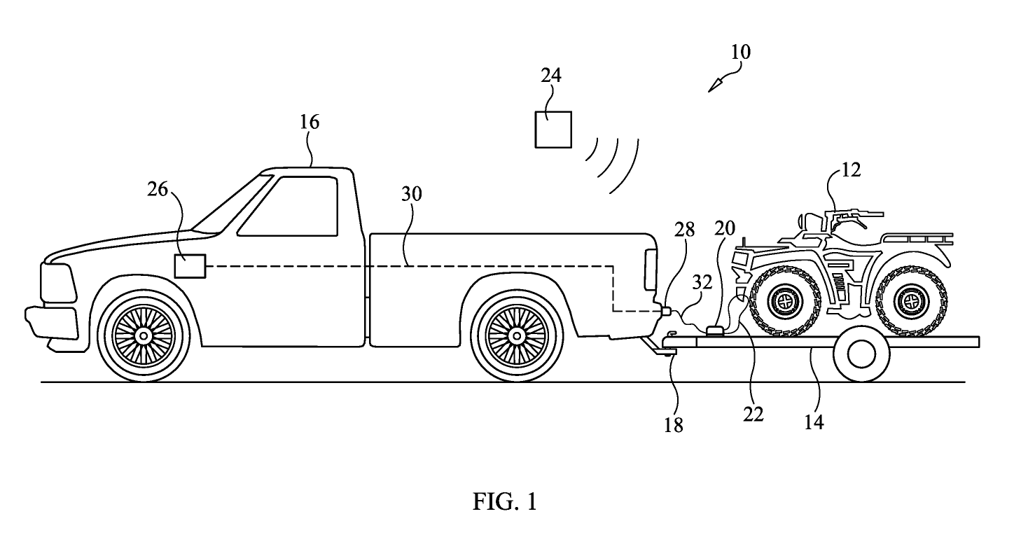

With initial reference to FIG. 1, there is diagrammatically shown a cargo alarm system 10 in accordance with an embodiment of the present invention. In this representatively illustrated embodiment, the alarm system 10 is configured to prevent an unauthorized removal of an ATV from a trailer towed by a towing vehicle.

As shown, an ATV 12 is carried on a trailer 14 that is coupled to a towing vehicle 16 by a coupling, such as hitch 18. The alarm system 10 includes an alarm housing 20 that is securely attached to the trailer 14. As further explained below, an electrical cable 22 is strung or routed through the frame of the ATV and electrically connected at its opposite ends to an alarm unit contained by housing 20. The alarm system 10 operates to detect tampering with cable 22, such as the cable being disconnected from the alarm unit, being cut, or being pulled upon. Upon detecting a tampering event, both the alarm system 10 generates an alarm signal, for example, sounding siren and flashing lights.

In embodiments, the alarm system 10 may be activated or deactivated by a wireless remote device, such as a key fob 24 or by an application running on mobile electronic device. In some instances, the key fob 24 may be configured to alert an alarm detecting by sounding a noise, vibrating, illuminating a light, for example.

As further depicted, in some embodiments, the alarm system 10 may be electrically connected to truck battery 26 to receive electrical power for operation. For example, an electrical coupling 28 may be attached to the truck 16 in a location that makes it readily accessible by a user from the exterior of the vehicle. In the depicted embodiment, electrical coupling 28 is located at the back of the towing vehicle 16 in a location approximate to the hitch 18. Electrical coupling 28 is electrically connected to the truck battery 26 by electrical wiring 30 and a second electrical cable 32 connects the alarm unit to the truck battery by connection to the electrical coupling.

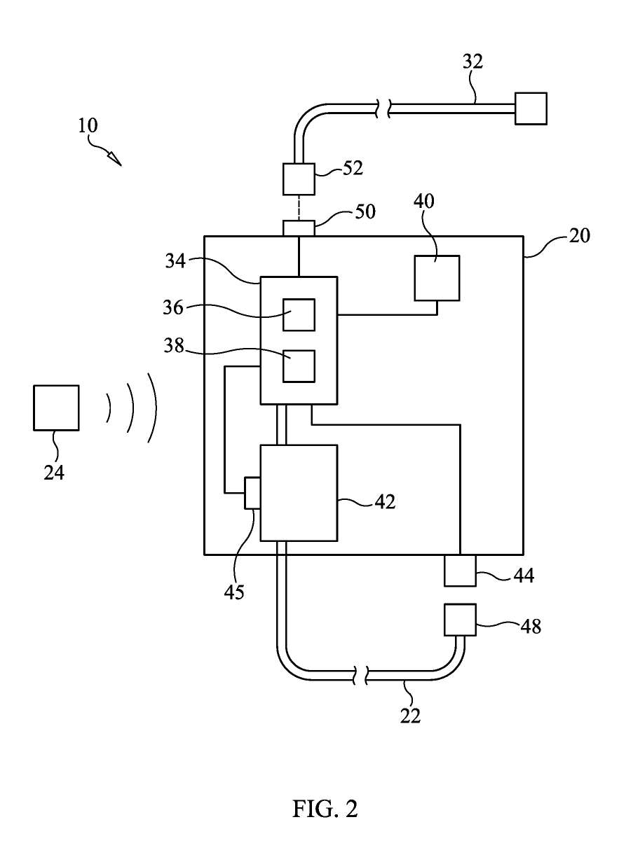

With reference to FIG. 2, a schematic diagram of the alarm system 10 is shown. As depicted, in an embodiment, the alarm system includes an alarm unit 34 contained within housing 20. The alarm unit 34 includes a siren 36 and lights 38. A battery 40 is electrically connected to the alarm unit 34 and provides electrical power for operation when the alarm unit is not electrically connected to towing vehicle battery 26. The cable is wound upon cable reel 42 and is connected at one end to the alarm unit 34 and has an electrical connector 48 at its opposite free end that is configured for connection with electrical coupling 44 that is electrically connected to the alarm unit. A rotation detecting sensor 45 is operatively connected to the cable reel 42 to sense or detect rotation of the cable reel. Sensor 45 is electrically connected to alarm unit 34 and operates to output a signal to the alarm unit upon detecting rotation of the cable reel. As further shown, the alarm unit 34 is electrically connected to electrical coupling 50 that is configured to connect with electrical coupling 52 that is connected to an end of power cable 32.

In an embodiment, upon detecting tampering of cable 22 by sensor 45, the alarm unit 34 may operate to alert at the alarm and at the key fob 24 with chirps letting the owner know of the tapering and notifying the person doing the tampering that it has been detected.

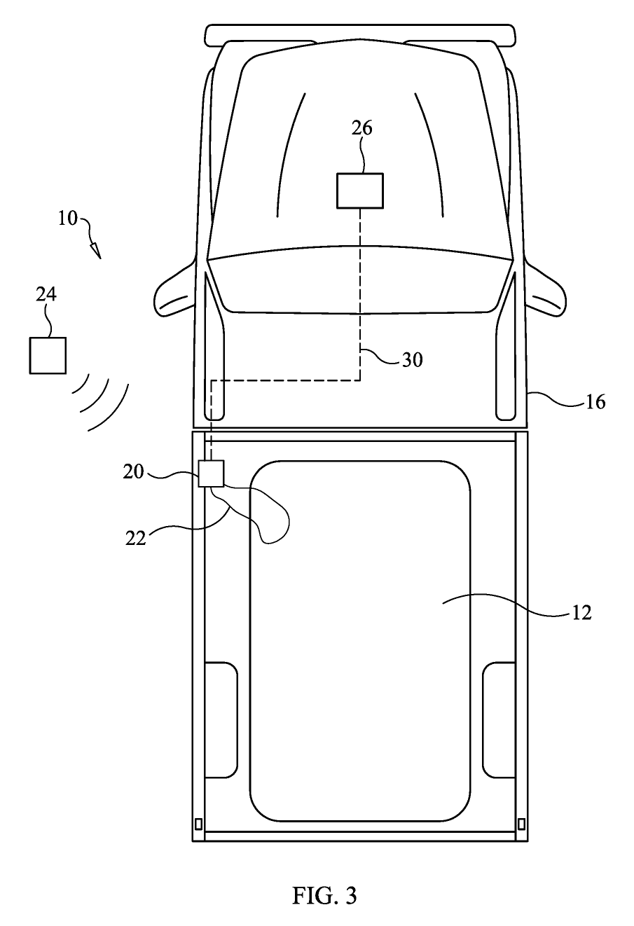

With reference to FIG. 3, the alarm system 10 is diagrammatically shown in an alternative configuration where cargo, such as the ATV 12, is disposed within the bed of pick-up truck 16. Here, housing 20 is securely mounted to the truck 16 rather than being mounted to a trailer.

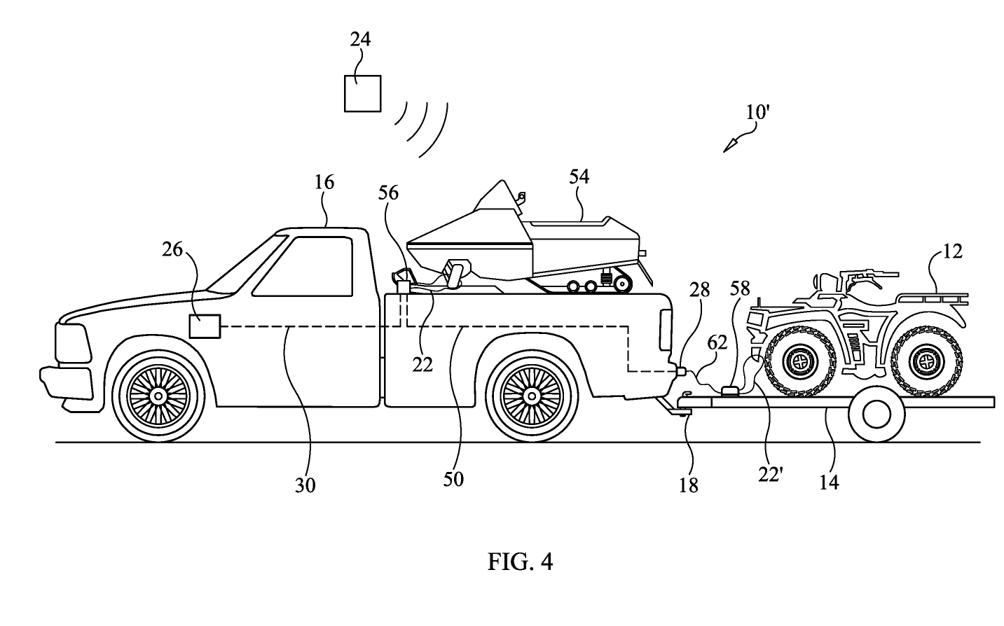

Turning now to FIG. 4, an alarm system 10′ is diagrammatically shown in accordance with an alternative embodiment. In this embodiment, alarm system 10′ includes separate alarm units electrically connected together forming an alarm network for securing various cargo articles. In the representatively illustrated configuration, alarm system 10′ is configured to secure an article carried by truck 16 and an article carried by trailer 14. As depicted, the article carried by the truck 16 is representatively a snowmobile 54 and the article carried by the trailer 14 is representatively an ATV 12.

Alarm system 10′ includes a master alarm 56 and one or more slave alarms 58. As shown, master alarm 56 is mounted to the truck 16 and a slave alarm 58 is mounted to the trailer 14. The master alarm 56 and slave alarm 58 are electrically and operatively connected together such that both alarms can be controlled by the key fob 24 or similar device as described above.

As shown, master alarm 56 is electrically connected to truck battery 26 by electrical cable 30 to receive power from the battery. The master alarm 56 is also electrically connected to electrical connector 28 by line 60. The slave alarm 58 is electrically connected to electrical connector 28 by cable 62, thereby electrically connecting the slave alarm with the master alarm.

Similar to alarm system 10, described above, and depicted in FIGS. 1-3, the master alarm 56 includes an electric cable 22 that is strung or routed through the frame of the snowmobile 54 and electrically connected at its opposite ends to an alarm unit of the master alarm. Each slave alarm 58 also includes an electric cable 22′ that is strung or routed through the device being secured, here the ATV. The master alarm 56 operates to detect tampering with its cable 22, such as the cable being disconnected from the alarm unit or being cut. Upon detecting a tampering event, the master alarm 56 generates an alarm signal, for example, sounding siren and flashing lights. Similarly, slave alarm 58 operates to detect tampering with its cable 22′, such as the cable being disconnected from the alarm unit or being cut. Upon detecting a tampering event, the slave alarm 58 generates an alarm signal, for example, sounding siren and flashing lights. In aspects, both the slave alarm 58 and the master alarm 56 may operate to generate an alarm signal when either alarm detects cable tampering.

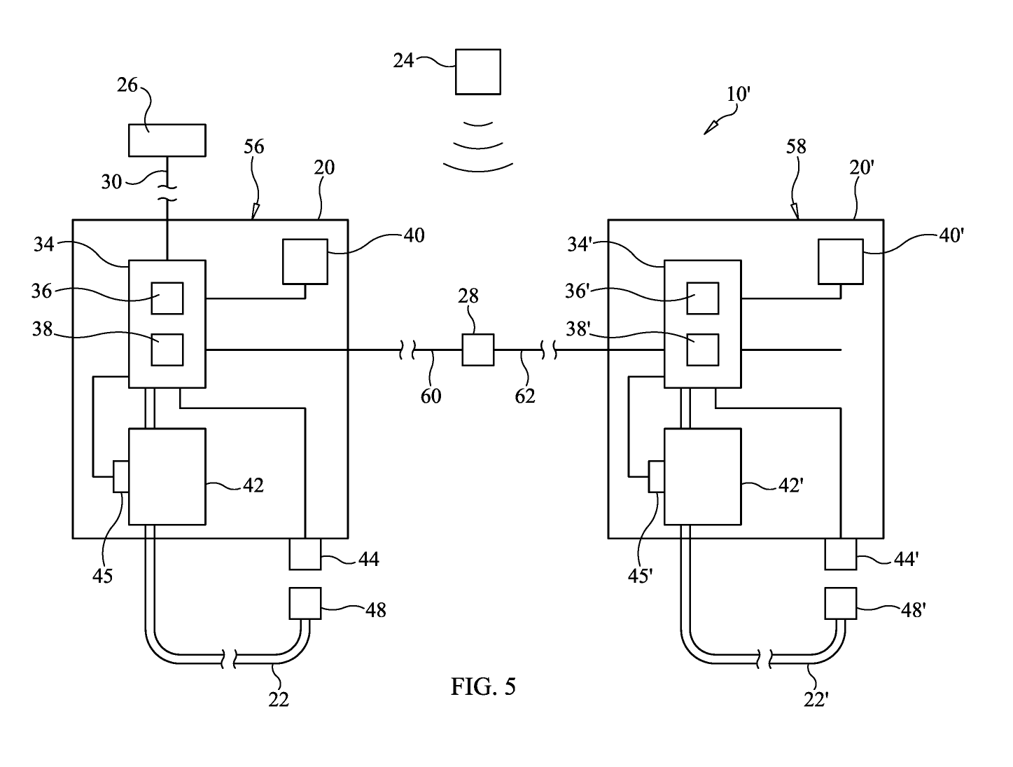

With reference to FIG. 5, a schematic diagram of the alarm system 10′ is shown. As depicted, in an embodiment, the alarm system 10′ includes an alarm unit 34 contained within housing 20 of master alarm 56. The alarm unit 34 includes a siren 36 and lights 38. A battery 40 is electrically connected to the alarm unit 34 and provides electrical power for operation when the alarm unit is not electrically connected to towing vehicle battery 26. The alarm unit 34 is electrically connected to two electrical couplings 42 and 44 that are configured for connection with electrical couplings 46 and 48 that are connected to opposite ends of electrical cable 22.

As further depicted, the alarm system 10′ includes an alarm unit 34′ contained within housing 20′ of slave alarm 58. The alarm unit 34′ includes a siren 36′ and lights 38′. A battery 40′ is electrically connected to the alarm unit 34′ and provides electrical power for operation when the alarm unit is not electrically connected to towing vehicle battery 26′. The alarm unit 34′ is electrically connected to two electrical couplings 42′ and 44′ that are configured for connection with electrical couplings 46′ and 48′ that are connected to opposite ends of electrical cable 22′.

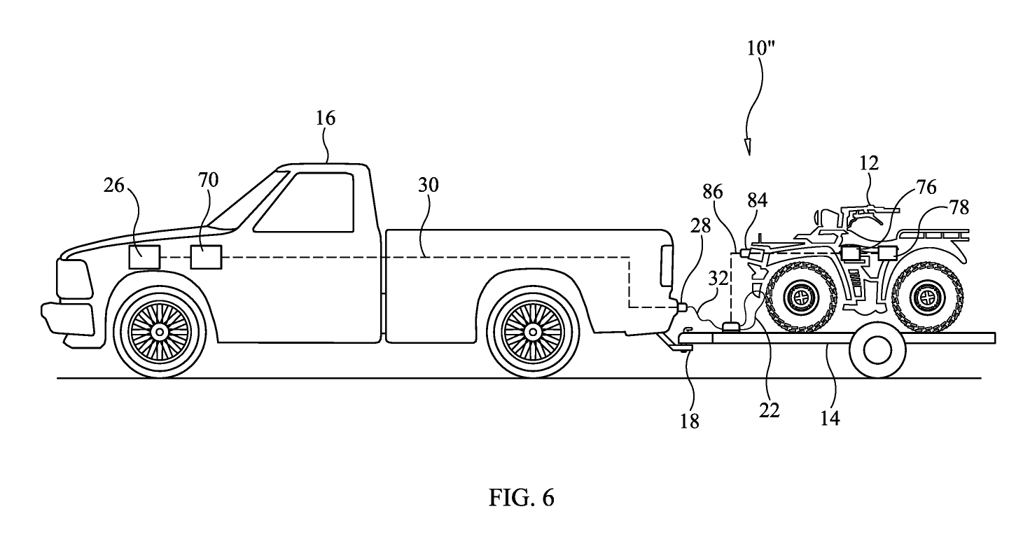

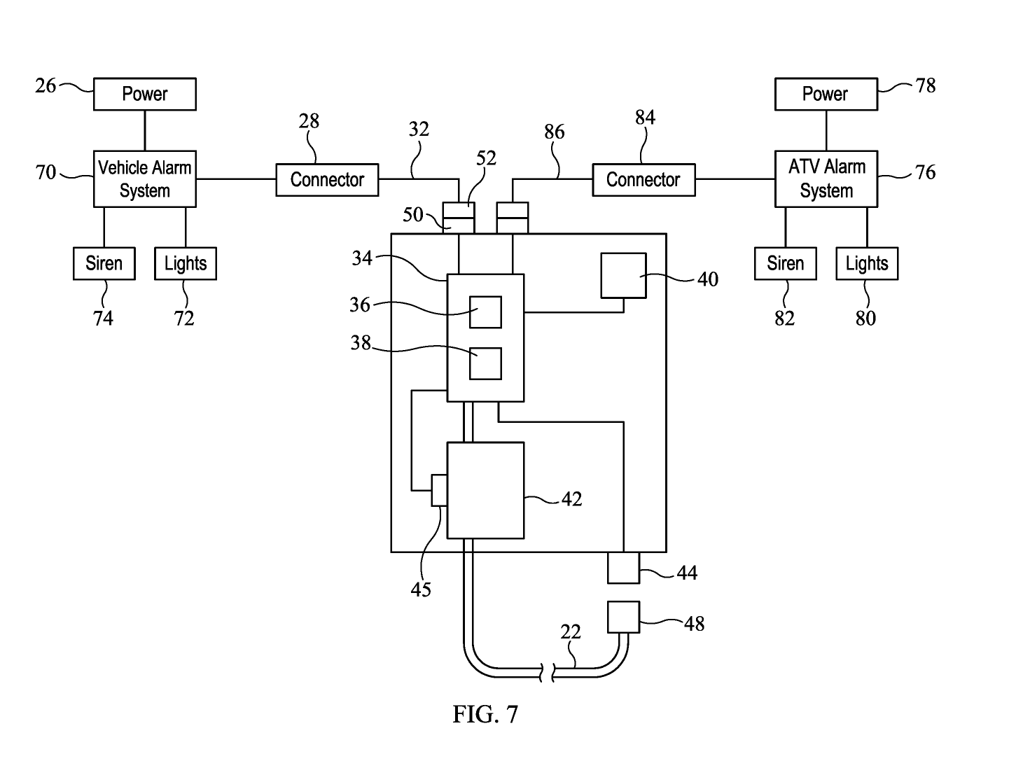

Turning now to FIGS. 6 and 7, an alarm system 10″ is diagrammatically shown in accordance with an alternative embodiment. As shown in FIG. 6, an ATV 12 is carried on a trailer 14 that is coupled to a towing vehicle 16 by a hitch 18. The towing vehicle 16 includes an alarm system 70 that is electrically connected to the vehicle battery 26, lighting system 72, siren and/or horn 74, and electrical connector 28. Electrical connector 28 is attached to the towing vehicle 16 in a location that makes it readily accessible by a user from the exterior of the vehicle. In the depicted embodiment, electrical connecter 28 is located at the back of the towing vehicle 16 in a location approximate to the hitch 18.

ATV 12 includes an alarm system 76 that is electrically connected to the ATV battery 78, ATV lighting system 80, siren and/or horn 82, and electrical connector 84. Electrical connector 84 is attached to the ATV 12 in a location that makes it readily accessible by a user from the exterior of the ATV. In the depicted embodiment, electrical connector 38 is located at the front of the ATV 12.

Alarm system 70 of the towing vehicle is connected to alarm system 20 by cable 32 that is connected to electrical connector 28. Alarm system 76 may be electrically connected to alarm system 20 either by hardwire cable shown as dashed line 86, which is connected to electrical coupling 84 or by a wireless interface not shown.

Alarm systems 20, 70, and 76 operate to detect separation from one another by either the cable 86 being disconnected or by the cable 86 being cut. Additionally, alarm systems 20, 70, and 76 operate to detect tampering with cable 22 as in the manner discussed above. Upon detecting tampering, all alarm systems 20, 70, and 76 generate an alarm signal, for example, by sounding sirens 74 and 82 and flashing lights 72 and 80.

The ATV anti-theft alarm system 10″ can be deactivated by an authorized person. For example, the alarm system 10″ may be activated or deactivated by a wireless remote device, such as a key fob or mobile electronic device. Further, the alarm system 10″ may include a GPS tracking module on the ATV 12 allowing a user to track the location of the ATV if stolen.

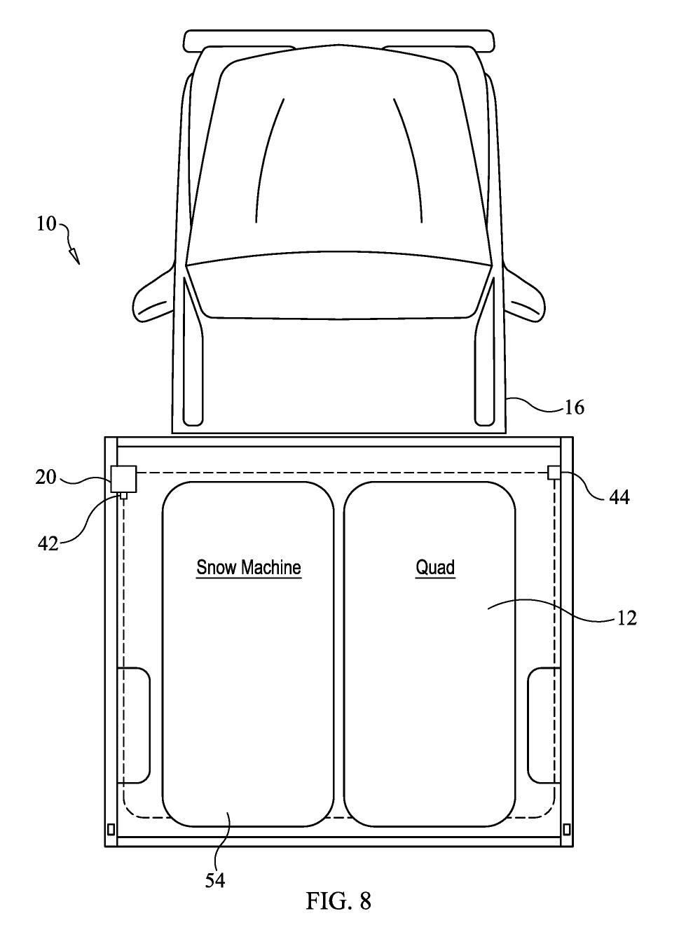

In FIG. 8, there is shown a diagrammatic embodiment that can be used in any of the foregoing described embodiments, wherein one electrical connector for an alarm system is in a position separately from its housing to allow running the alarm cable from one side of the vehicle to the opposite side. For example, as depicted, alarm system 10 is mounted to vehicle 16 and is securing articles, such as, ATV 12 and snowmobile 54. As shown, electrical connector 42 is disposed at alarm housing 20 and electrical connector 44 is positioned on the opposite side of the vehicle from the alarm housing. In such an arrangement, electrical cable 22 is connected at one end to electrical connector 42, strung through ATV 12 and snowmobile 54, and then connected at its opposite end to electrical connector 44.

Several embodiments of the present invention have been described. Nevertheless, it will be understood that various modifications may be made without departing from the spirit and scope of the invention. For example, although the above description is made in connection with ATV 12, the present invention could be modified for other person vehicles such as, for example, a wave-runner, a motorcycle, etc. Accordingly, other embodiments are within the scope of the following claims.

1. An alarm system comprising:
a first vehicle;
an alarm system housing mounted to said first vehicle;
an alarm unit contained by said alarm system housing;
a first electrical connector electrically connected to said alarm unit;
a second electrical connector electrically connected to said alarm unit;
a second vehicle;
an electrical cable having a length and terminating at opposite first and second ends, said electrical cable removably threaded through a portion of said second vehicle and, said first end of said electrical cable removably and electrically connected at said first end to said first electrical connector and said second end of said electrical cable removably and electrically connected to said second electrical connector; and
wherein said alarm unit sounding an alarm signal upon unplugging said electrical cable from either of said first or second electrical connectors or upon cutting of said electrical cable.

2. The alarm system of claim 1, wherein said first vehicle is a towing vehicle.

3. The alarm system of claim 1, wherein said first vehicle is a trailer.

4. The alarm system of claim 1, wherein said alarm unit is electrically connected to a towing vehicle battery.

5. The alarm system of claim 1, wherein said first and said second electrical connectors are located on opposite sides of said first vehicle.

6. An alarm system comprising:
a master alarm having a master alarm housing mounted to a vehicle, a master alarm unit contained by said master alarm housing, a first electrical connector electrically connected to said master alarm unit, a second electrical connector electrically connected to said master alarm unit, a master alarm electrical cable electrically connectable at one end to said first electrical connector and at the opposite end to said second electrical connector;
a slave alarm having housing mounted to a vehicle, a slave alarm unit contained by said slave alarm housing, a third electrical connector electrically connected to said slave alarm unit, a fourth electrical connector electrically connected to said slave alarm unit, a slave alarm electrical cable electrically connectable at one end to said third electrical connector and at the opposite end to said fourth electrical connector;
said slave alarm unit and said master alarm unit electrically connected together;
wherein said master alarm unit operates to detect cutting or unplugging of said master electrical cable and generating an alarm signal in response; and
wherein said slave alarm unit operates to detect cutting or unplugging of said slave electrical cable and generating an alarm signal in response.

7. An alarm system comprising:
a towing vehicle alarm system associated with a towing vehicle;
a towing vehicle electrical connector electrically connected to said towing vehicle alarm system;
a towed vehicle alarm system associated with a towed vehicle;
a towed vehicle electrical connector electrically connected to said towed vehicle alarm system;
a cable electrically connected at opposite ends to said towing vehicle electrical connector and said towed vehicle electrical connector; and
wherein each of said towing vehicle alarm system and said towed vehicle alarm system generate an alarm signal upon detecting an electrical separation between said towing vehicle alarm system and said towed vehicle alarm system.

8. The alarm system of claim 7, wherein said towing vehicle electrical connector is attached to the back of the towing vehicle.

9. The alarm system of claim 7, wherein said towed vehicle electrical connector is attached to the front of the towed vehicle.

10. The alarm system of claim 7, wherein said cable extends between the towing vehicle and the towed vehicle.

11. The alarm system of claim 7, wherein said alarm signal generated by said towing vehicle alarm system includes sounding a siren and flashing lights of the towing vehicle.

12. The alarm system of claim 7, wherein said alarm signal generated by said towed vehicle alarm system includes sounding a siren and flashing lights of the towed vehicle.
